(19) United States
(12) Patent Application Publication
(10) Pub. No.: US 2025/0247176 A1
(43) Pub. Date: Jul. 31, 2025

(54) HYBRID AUTOMATIC REPEAT REQUEST (HARQ) FEEDBACK DESIGN FOR USER EQUIPMENT (UE) HELPING PASSIVE INTERNET OF THINGS (IOT) DEVICES

(71) Applicant: QUALCOMM Incorporated, San Diego, CA (US)

(72) Inventors: Ahmed ELSHAFIE, San Diego, CA (US); Huilin XU, Temecula, CA (US); Seyedkianoush HOSSEINI, San Diego, CA (US); Yuchul KIM, San Diego, CA (US); Zhikun WU, Beijing (CN); Linhai HE, San Diego, CA (US)

(21) Appl. No.: 19/112,207

(22) PCT Filed: Nov. 15, 2022
(86) PCT No.: PCT/CN2022/131845

§ 371 Date: Mar. 14, 2025

(51) Int. Cl. H04L 1/1867; H04L 1/00; H04L 1/1829; H04W 72/21

(52) U.S. Cl. CPC H04L 1/1896; H04L 1/1861; H04W 72/21; H04L 2001/0097

(57) ABSTRACT

Certain aspects of the present disclosure provide a method for wireless communications by a user equipment (UE). The UE receives signaling indicating a set of resources from a network entity for transmitting a set of transmissions. The set of transmissions may include a first transmission corresponding to a successful or unsuccessful reception of data from at least one harvesting energy device at the UE and/or a second transmission corresponding to a successful or unsuccessful reception of a command or a query from a wireless communications device at the at least one harvesting energy device. The UE transmits the set of transmissions on the set of resources.

### BACKGROUND

### Field of the Disclosure

Aspects of the present disclosure relate to wireless communications, and more particularly, to techniques for managing hybrid automatic repeat request (HARQ) feedback resources.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a user equipment (UE), comprising: receiving signaling indicating a set of resources from a network entity for transmitting a set of transmissions comprising at least one of: a first transmission corresponding to a successful or unsuccessful reception of data from at least one harvesting energy device at the UE, or a second transmission corresponding to a successful or unsuccessful reception of a command or a query from a wireless communications device at the at least one harvesting energy device; and transmitting the set of transmissions on the set of resources.

Another aspect provides a method for wireless communications by a network entity, comprising: transmitting signaling indicating a set of resources to a UE for a set of transmissions comprising at least one of: a first transmission corresponding to a successful or unsuccessful reception of data from at least one harvesting energy device at the UE, or a second transmission corresponding to a successful or unsuccessful reception of a command or a query from a wireless communications device at the at least one harvesting energy device; and receiving the set of transmissions on the set of resources.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example BS and an example user equipment (UE).

FIGS. 4A, 4B, 4C, and 4D depict various example aspects of data structures for a wireless communications network.

FIGS. 5A-5B depict diagrammatic representations of example vehicle-to-everything (V2X) systems.

FIG. 6 depicts example mapping between a sidelink channel and a corresponding sidelink resource.

FIG. 7 depicts example radio frequency identification (RFID) system.

FIG. 8 depicts example communication between UEs and an RFID tag in an RFID-based wireless communications system.

FIGS. 9A-9C depict example signals transmitted or received by various devices of an RFID-based wireless communications system.

FIG. 10 depicts example backscatter communication.

FIG. 11 depicts example communication between devices of an RFID-based wireless communications system.

FIG. 12 depicts a call flow diagram illustrating example communication between a UE and a network entity.

FIG. 13 depicts example hybrid automatic repeat request (HARQ) feedback from a UE to a network entity.

FIG. 14 depicts example HARQ feedback from one UE to another UE, and another HARQ feedback from one UE to a network entity.

FIG. 15 depicts example HARQ feedback from a UE to a network entity.

FIGS. 16-17 depict example physical resource blocks (PRBs) for resources within a resource pool.

FIG. 18 depicts a method for wireless communications by a UE.

FIG. 19 depicts a method for wireless communications by a network entity.

FIG. 20 depicts an example communications device.

### DETAILED DESCRIPTION

Aspects of the present disclosure provide apparatuses, methods, processing systems, and computer-readable mediums for managing hybrid automatic repeat request (HARQ) feedback resources.

In an radio frequency identification (RFID)-based wireless communications system, certain devices known as zero power passive internet of things (ZP-IoT) devices may be capable of harvesting energy from one or more wireless energy sources, such as radio frequency (RF) signals, thermal energy, solar energy, etc. In some cases, when the RF signals are used for energy harvesting in ZP-IoT communication, a first device, such as an RFID reader device, may transmit an energy signal to a second device, such as a ZP-IoT device. The second device may then harvest energy from the energy signal (e.g., using energy harvesting circuitry such as an RFID tag) and use this harvested energy to power one or more other components of the second device. After a sufficient amount of energy is accumulated, the second device may begin to modulate the energy signal with transmission bits and transmit the energy signal back to the first device, known as a backscatter signal or backscatter communication.

In the RFID-based wireless communications system, an RFID source device (e.g., user equipment (UE) in sidelink operations or network entity in Uu link operations) may send signals and/or commands (e.g., backscatter data after a certain time) to an RFID tag. In response to the received commands, the RFID tag may send a response (i.e., backscatter the data after the certain time). An RFID reader device (e.g., UE) may read the backscattered data and/or collect the signals from the RFID tag.

The communications of the RFID-based wireless communications system may include feedback signaling. One form of feedback is a hybrid automatic repeat request (HARQ) feedback. In the RFID-based wireless communications system, there may be a need for multiple HARQ feedbacks, which may have to be reported by the RFID reader device to the RFID source device, so that the RFID source device does not repeat sending the commands (e.g., when the commands have been correctly received and decoded at the RFID tag) and/or the signals (e.g., when the signals have been correctly received and read by the RFID reader device) to the RFID tag. Accordingly, there is a need to configure multiple HARQ feedback resources for the multiple HARQ feedbacks.

Techniques proposed herein may assign multiple HARQ feedback resources to an RFID reader device operating in an RFID-based wireless communications system. For example, a network entity may assign dedicated HARQ feedback resources to the RFID reader device for at least a first HARQ feedback (e.g., corresponding to reception/decoding of commands sent by an RFID source device to an RFID tag) and a second HARQ feedback (e.g., corresponding to reading of signals by the RFID reader device from the RFID tag). Techniques proposed herein may reduce over-the-air latency by promptly providing the HARQ feedbacks to the RFID source device, so that the RFID source device is able to quickly resend the commands and/or the signals if needed.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

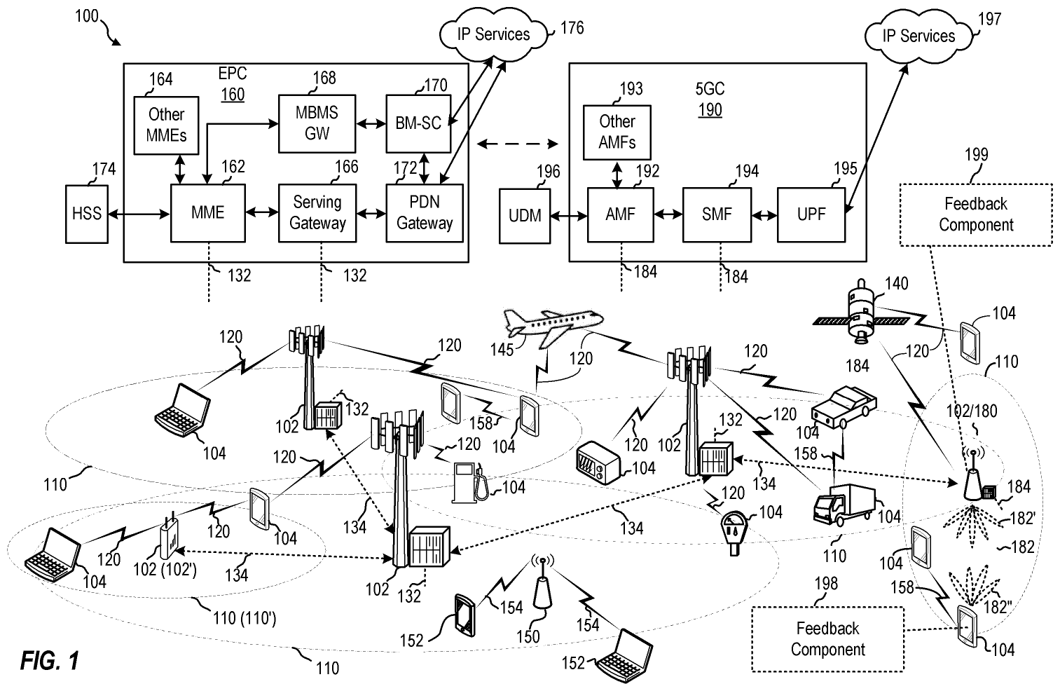

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

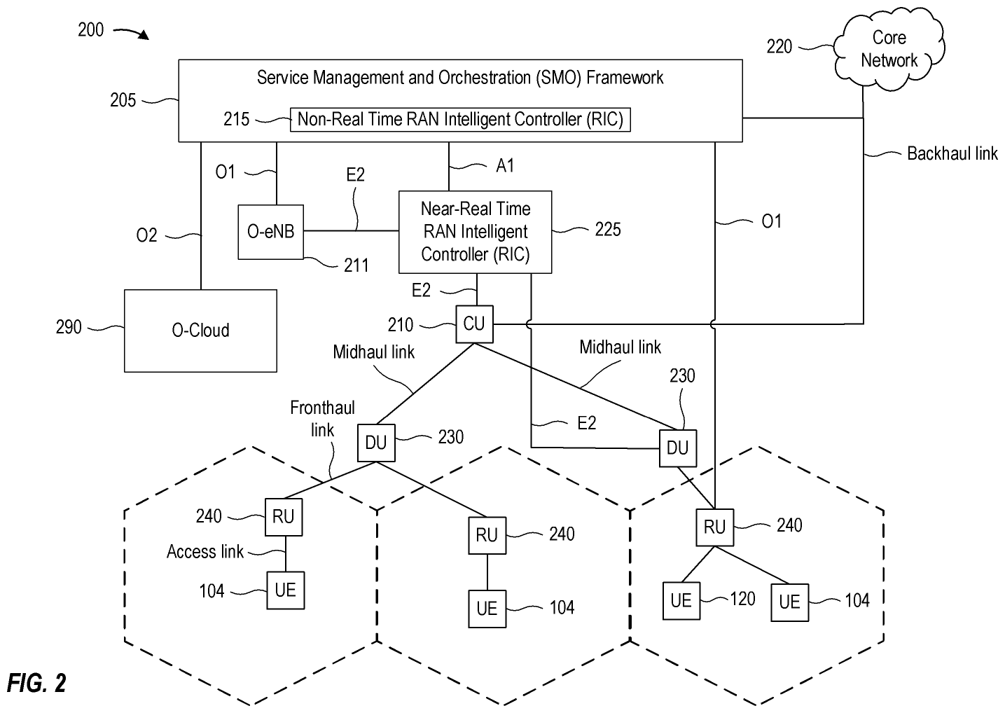

While BSs 102 are depicted in various aspects as unitary communications devices, BSs 102 may be implemented in various configurations. For example, one or more components of a BS 102 may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHZ-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A BS configured to communicate using mm Wave/near mmWave radio frequency bands (e.g., a mmWave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

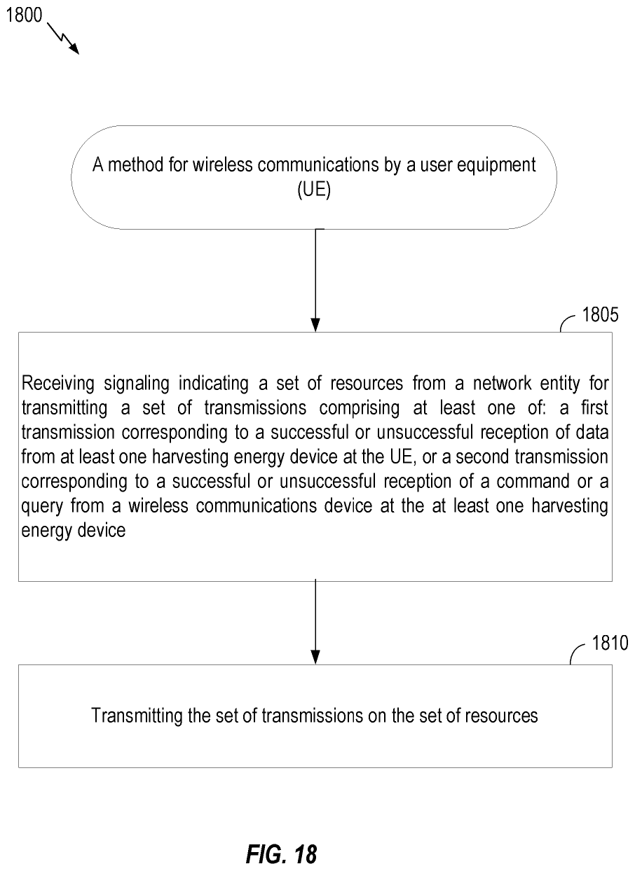

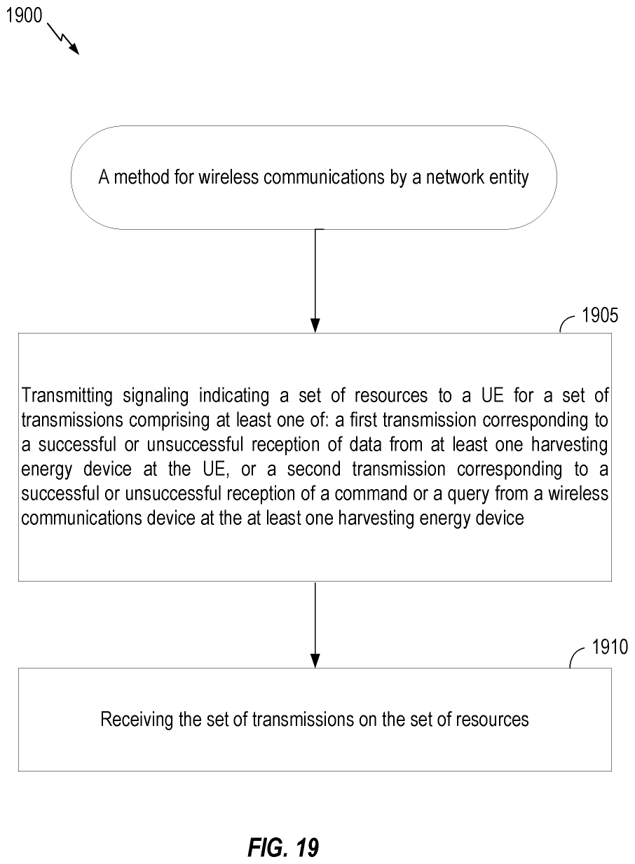

Wireless communication network 100 further includes feedback component 198, which may be configured to perform method 1800 of FIG. 18. Wireless communication network 100 further includes feedback component 199, which may be configured to perform method 1900 of FIG. 19.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

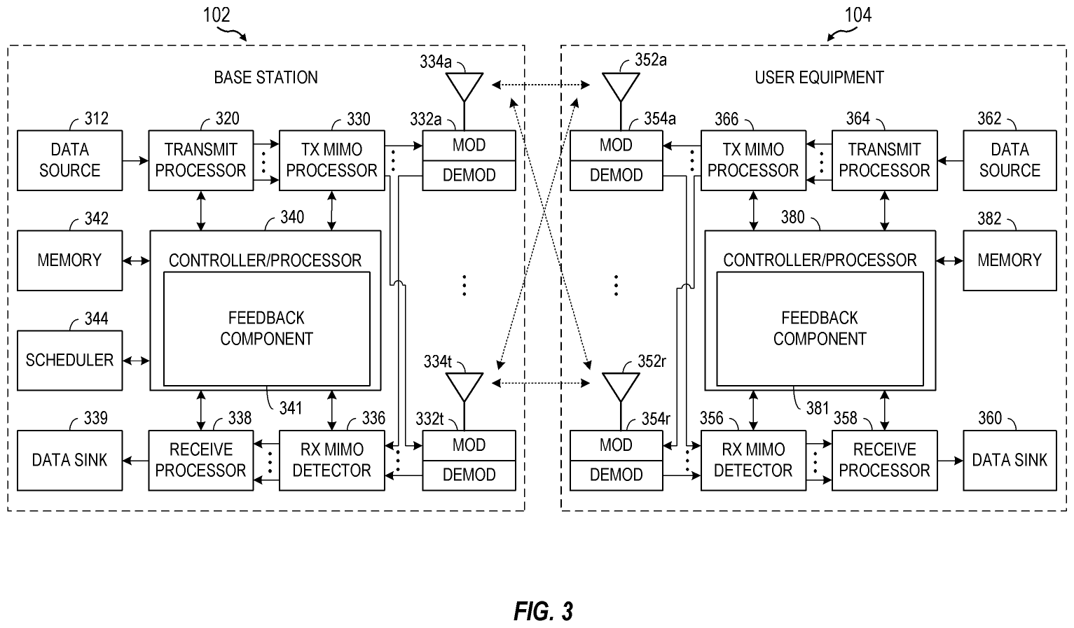

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes feedback component 341, which may be representative of feedback component 199 of FIG. 1. Notably, while depicted as an aspect of controller/processor 340, feedback component 341 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes feedback component 381, which may be representative of feedback component 198 of FIG. 1. Notably, while depicted as an aspect of controller/processor 380, feedback component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

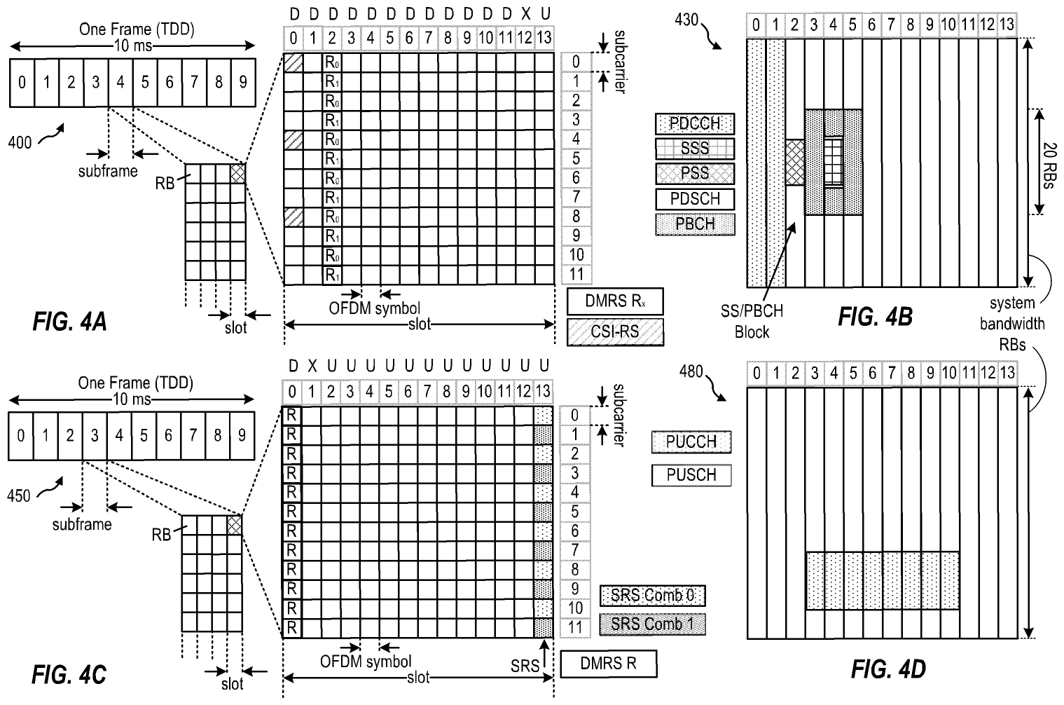

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5^{th} generation (5G) networks may utilize several frequency ranges, which in some cases are defined by a standard, such as 3rd generation partnership project (3GPP) standards. For example, 3GPP technical standard TS 38.101 currently defines Frequency Range 1 (FR1) as including 600 MHZ-6 GHz, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mm Wave/near mm Wave radio frequency band (e.g., 3 GHz-300 GHz) may have higher path loss and a shorter range compared to lower frequency communications. As described above with respect to FIG. 1, a base station (BS) (e.g., 180) configured to communicate using mmWave/near mmWave radio frequency bands may utilize beamforming (e.g., 182) with a user equipment (UE) (e.g., 104) to improve path loss and range.

### Example Hybrid Automatic Repeat Request (HARQ) Feedback

In certain communication systems, there is an ongoing effort to reduce latency. For example, in 5G New Radio (NR) systems, there is an ongoing effort to reduce over-the-air latency. The NR system may include communications that are limited in time. As a result, some types of communications include feedback signaling.

One form of feedback is hybrid automatic repeat request (HARQ) feedback. HARQ feedback may be provided by a receiver device (e.g., a user equipment (UE)) to a transmitter device (e.g., a network entity), and may include transmission of several reporting signals to the transmitter device. Example reporting signals may include acknowledgement (ACK) signals representing an ACK state, and negative acknowledgement (NACK) signals representing a NACK state. An ACK signal may be transmitted as part of the HARQ feedback, in response to successful reception and decoding of a data transmission. A NACK signal may be transmitted as part of the HARQ feedback, in response to a reception of a data transmission but an unsuccessful decoding of the data transmission.

### Example Sidelink Systems

User equipments (UEs) communicate with each other using sidelink signals. Real-world applications of sidelink communications may include UE-to-network relaying, vehicle-to-vehicle (V2V) communications, vehicle-to-everything (V2X) communications, Internet of Everything (IoE) communications, IoT communications, mission-critical mesh, and/or various other suitable applications.

A sidelink signal refers to a signal communicated from one UE to another UE without relaying that communication through a scheduling entity (e.g., UE or a network entity), even though the scheduling entity may be utilized for scheduling and/or control purposes. In some examples, the sidelink signal is communicated using a licensed spectrum (e.g., unlike wireless local area networks, which typically use an unlicensed spectrum). One example of sidelink communication is PC5, for example, as used in V2V, long term evolution (LTE), and/or new radio (NR).

Various sidelink channels are used for sidelink communications, including a physical sidelink discovery channel (PSDCH), a physical sidelink control channel (PSCCH), a physical sidelink shared channel (PSSCH), and a physical sidelink feedback channel (PSFCH). The PSDCH carries discovery expressions that enable proximal UEs to discover each other. The PSCCH carries control signaling such as sidelink resource configurations, resource reservations, and other parameters used for data transmissions. The PSSCH carries data transmissions. The PSFCH may be used to communicate sidelink feedback, such as hybrid automatic repeat request (HARQ) feedback (e.g., acknowledgement or negative acknowledgement (ACK or NACK) information corresponding to transmissions on the PSSCH), transmit power control (TPC), and/or a scheduling request (SR).

In some NR systems, a two stage sidelink control information (SCI) is supported. The two stage SCI includes a first stage SCI (e.g., SCI-1) and a second stage SCI (e.g., SCI-2). The SCI-1 includes resource reservation and allocation information. The SCI-2 includes information that can be used to decode data and to determine whether a UE is an intended recipient of a transmission. The SCI-1 and/or the SCI-2 may be transmitted over a PSCCH.

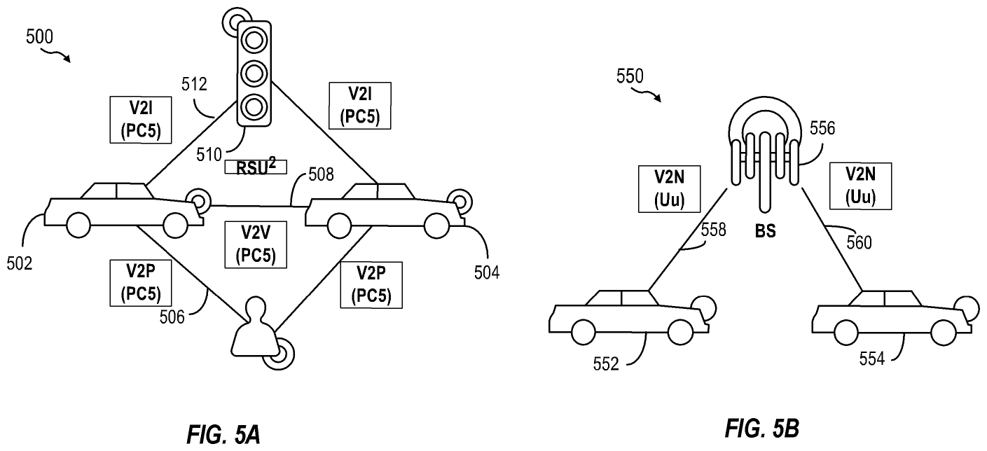

FIG. 5A and FIG. 5B show diagrammatic representations of example V2X systems. For example, vehicles shown in FIG. 5A and FIG. 5B communicate via sidelink channels and relay sidelink transmissions. V2X is a vehicular technology system that enables vehicles to communicate with traffic and an environment around them using short-range wireless signals, known as sidelink signals.

The V2X systems shown in FIG. 5A and FIG. 5B provide two complementary transmission modes. A first transmission mode, shown by way of example in FIG. 5A, involves direct communications (e.g., also referred to as sidelink communications) between participants in proximity to one another in a local area. A second transmission mode, shown by way of example in FIG. 5B, involves network communications through a network, which may be implemented over a Uu interface (for example, a wireless communication interface between a radio access network (RAN) and a UE).

Referring to FIG. 5A, a V2X system 500 (e.g., including V2V communications) is illustrated with two vehicles 502, 504. A first transmission mode allows for direct communication between different participants in a given geographic location. As illustrated, a vehicle 502 can have a wireless communication link 506 with an individual through a PC5 interface. Communications between the vehicles 502 and 504 may also occur through a PC5 interface 508. In a like manner, communication may occur from the vehicle 502 to other highway components (e.g., a roadside unit (RSU) 510), such as a traffic signal or sign through a PC5 interface 512. With respect to each communication link illustrated in FIG. 5A, two-way communication may take place between devices, therefore each device may be a transmitter and a receiver of information. The V2X system 500 is a self-managed system implemented without assistance from a network entity. A self-managed system may enable improved spectral efficiency, reduced cost, and increased reliability as network service interruptions do not occur during handover operations for moving vehicles. The V2X system 500 is configured to operate in a licensed or unlicensed spectrum, thus any vehicle with an equipped system may access a common frequency and share information. Such harmonized/common spectrum operations allow for safe and reliable operation.

FIG. 5B shows a V2X system 550 for communication between a vehicle 552 and a vehicle 554 through a network entity 556. Network communications may occur through discrete nodes, such as a network entity 556 that sends and receives information to and from (e.g., relays information between) the vehicles 552, 554. The network communications through vehicle to network (V2N) links 558 and 560 may be used, for example, for long-range communications between the vehicles 552, 554, such as for communicating the presence of a car accident a distance ahead along a road or highway. Other types of communications may be sent by a wireless node to the vehicles 552, 554, such as traffic flow conditions, road hazard warnings, environmental/weather reports, and service station availability, among other examples. Such data can be obtained from cloud-based sharing services.

In some cases, the sidelink channels may use resource pools. For example, a scheduling assignment (e.g., included in SCI) may be transmitted in subchannels using specific resource blocks (RBs) across time. In some cases, data transmissions (e.g., on the PSSCH) associated with a scheduling assignment may occupy adjacent RBs in the same subframe as the scheduling assignment (e.g., using frequency division multiplexing). In some cases, a scheduling assignment and associated data transmissions are not transmitted on adjacent RBs. In some cases, a resource pool can be configured to have a number of RBs that are not multiples of the domain frequency reservation units (e.g., subchannels). These RBs may be unused spare RBs.

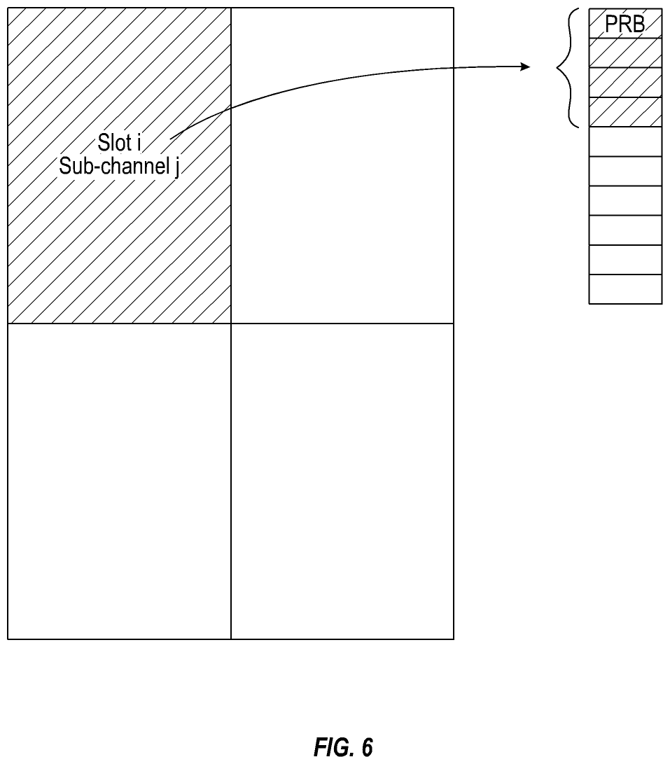

In some cases, a sidelink transmission may be mapped to a corresponding sidelink resource. For example, a mapping between a PSSCH transmission and a corresponding PSFCH resource may be based on a starting sub-channel of the PSSCH transmission (e.g., sl-PSFCH-CandidateResourceType is configured as startSubCH). In another example, the mapping between the PSSCH transmission and the corresponding PSFCH resource may be based on a number of subchannels in the PSSCH transmission (e.g., sl-PSFCH-CandidateResourceType is configured as allocSubCH). In another example, the mapping between the PSSCH transmission and the corresponding PSFCH resource may be based on a slot containing the PSSCH transmission (e.g., as illustrated in FIG. 6). In another example, the mapping between the PSSCH transmission and the corresponding PSFCH resource may be based on a source device ID. In another example, the mapping between the PSSCH transmission and the corresponding PSFCH resource may be based on a destination device ID. In another example, the mapping between the PSSCH transmission and the corresponding PSFCH resource may be based on a number of potential PRBs to use based on a slot index and a starting subchannel (or a number of subchannels in another mode of operation). In some cases, a number of available PSFCH resources may be equal to or greater than a number of UEs (e.g., in groupcast option 2 where a receiver UE may transmit both HARQ ACK/NACK feedbacks).

### Example Energy Harvesting in Radio Frequency Identification (RFID) Systems

Radio frequency identification (RFID) is a rapidly growing technology impacting many industries due to its economic potential for inventory/asset management within warehouses, internet of things (IoT), sustainable sensor networks in factories and/or agriculture, and smart homes, to name a few example applications. RFID technology consists of RFID devices (or backscatter devices), such as transponders, or RFID tags, that emit an information-bearing signal upon receiving an energizing signal.

RFID devices may be operated without a battery. RFID devices that are operated without a battery are known as passive RFID devices. Passive RFID devices may operate by harvesting energy from received radio frequency (RF) signals (e.g., “over the air”), thereby powering reception and transmission circuitry within the RFID devices. This harvested energy allows the passive RFID devices to transmit information, sometimes referred to as backscatter modulated information, without the need for a local power source within the RFID device. On the other hand, in certain aspects, RFID device may be semi-passive and include on-board energy storage to supplement their ability to harvest energy from received signals (however, at higher cost).

In some cases, in addition to harvesting power from RF sources, energy harvesting devices may accumulate energy from other direct energy sources, such as solar energy, in order to supplement its power demands. Semi-passive energy harvesting devices may, in some cases, include power consuming RF components, such as analog to digital converters (ADCs), mixers, and oscillators.

The RFID device may be a type of user equipment (UE) that provides low-cost and low-power solutions for many applications in a wireless communications system. The RFID device may be power efficient, sometimes requiring less than 0.1 mW of power to operate. Further, relatively simple architectures and, in some cases, lack of battery, mean that the RFID device can be small, lightweight, and easily installed or integrated in many types of environments or host devices. The RFID device provides practical and necessary solutions to many networking applications that require, low-cost, small footprint, durable, maintenance-free, and long lifespan communications devices. For example, the RFID device may be configured as long endurance industrial sensors, which mitigates the problems of replacing batteries in and around dangerous machinery.

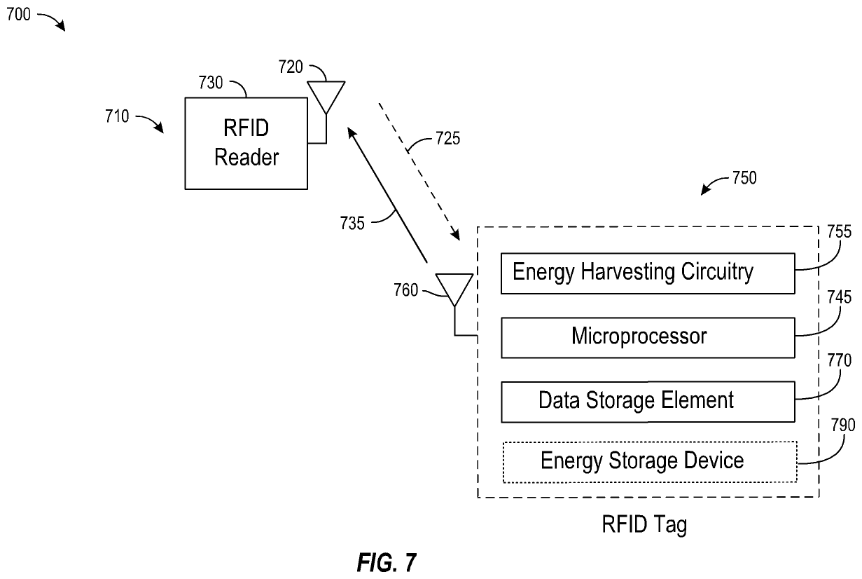

FIG. 7 shows an RFID system 700. As shown, the RFID system 700 includes an RFID reader 710 and an RFID tag 750. The RFID reader 710 may also be referred to as an interrogator or a scanner. The RFID tag 750 may also be referred to as an RFID label or an electronics label.

The RFID reader 710 includes an antenna 720 and an electronics unit 730. The antenna 720 radiates signals transmitted by the RFID reader 710 and receives signals from RFID tags and/or other devices. The electronics unit 730 may include a transmitter and a receiver for reading RFID tags such as the RFID tag 750. The same pair of transmitter and receiver (or another pair of transmitter and receiver) may support bi-directional communication with wireless networks, wireless devices, etc. The electronics unit 730 may include processing circuitry (e.g., a processor) to perform processing for data being transmitted and received by the RFID reader 710.

The RFID tag 750 includes an antenna 760 and a data storage element 770. The antenna 760 radiates signals transmitted by the RFID tag 750 and receives signals from the RFID reader 710 and/or other devices. The data storage element 770 stores information for the RFID tag 750, for example, in an electrically erasable programmable read-only memory (EEPROM) or another type of memory. The RFID tag 750 may also include an electronics unit that can process the received signal and generate the signals to be transmitted. The RFID tag 750 may be a passive RFID tag having no battery. In this case, induction may be used to power the RFID tag 750. For example, in some cases, a magnetic field from a signal transmitted by RFID reader 710 may induce an electrical current in RFID tag 750, which may then operate based on the induced current. The RFID tag 750 can radiate its signal in response to receiving a signal from the RFID reader 710 or some other device.

The RFID tag 750 may be read by placing the RFID reader 710 within close proximity to the RFID tag 750. The RFID reader 710 may radiate a first signal 725 via the antenna 720. In some cases, the first signal 725 may be known as an interrogation signal or energy signal. In some cases, energy of the first signal 725 may be coupled from the RFID reader antenna 720 to RFID tag antenna 760 via magnetic coupling and/or other phenomena. In other words, the RFID tag 750 may receive the first signal 725 from RFID reader 710 via antenna 760 and energy of the first signal 725 may be harvested using energy harvesting circuitry 755 and used to power the RFID tag 750.

For example, energy of the first signal 725 received by the RFID tag 750 may be used to power a microprocessor 745 of the RFID tag 750. The microprocessor 745 may, in turn, retrieve information stored in a data storage element 770 of the RFID tag 750 and transmit the retrieved information via a second signal 735 using the antenna 760. For example, in some cases, the microprocessor 745 may generate the second signal 735 by modulating a baseband signal (e.g., generated using energy of the first signal 725) with the information retrieved from the data storage element 770. In some cases, this second signal 735 may be known as a backscatter modulated information signal. Thereafter, as noted, the microprocessor 745 transmits the second signal 735 to the RFID reader 710. The RFID reader 710 may receive the second signal 735 from the RFID tag 750 via the antenna 720 and may process (e.g., demodulate) the received signal to obtain the information of the data storage element 770 sent in the second signal 735.

The RFID system 700 may be designed to operate at 13.56 MHz or some other frequency (e.g., an ultra-high frequency (UHF) band at 900 MHZ). The RFID reader 710 may have a specified maximum transmit power level, which may be imposed by the Federal Communication Commission (FCC) in the United Stated or other regulatory bodies in other countries. The specified maximum transmit power level of the RFID reader 710 may limit the distance at which RFID tag 750 can be read by RFID reader 710.

### Example Backscatter Communication Process

Wireless technology is increasingly useful in industrial applications, such as ultra-reliable low-latency communication (URLLC) and machine type communication (MTC). In such domains, and others, it is desirable to support devices (e.g., passive radio frequency identification (RFID) tags) that are capable of harvesting energy from wireless energy sources (e.g., in lieu of or in combination with a battery or other energy storage device, such as a capacitor), such as radio frequency (RF) signals, thermal energy, solar energy, and the like.

For example, in some cases, these devices may not include a local power storage component and may instead harvest energy from things such as RF signals, thermal energy, solar energy, etc. In some cases, these devices may be known as passive internet of things (PIOT) devices or more generally as zero power internet of things (ZP-IoT) devices. ZP-IoT devices may employ RFID-type technology and, as such, may not include a local power source. Instead, ZP-IoT devices may harvest energy from radio signals emitted from a reader device, such as a network entity or a user equipment (UE), for performing data collection, transmission and distributed computing.

ZP-IoT devices may have different use cases. For example, one ZP-IoT use case includes an industrial sensor use case where replacing batteries of communication devices is prohibitively difficult or undesirable (e.g., for safety monitoring or fault detection in smart factories, infrastructures, or environments). Another ZP-IoT use case includes a smart logistics/warehousing use case in which extremely-low cost, small size, maintenance-free, durable, long lifespan communication devices are used, for example, for performing automated asset management in factories. Another ZP-IoT use case includes a smart home network for household item management, wearables, and environment monitoring (e.g., a wearable device for medical monitoring where that does not require battery replacement).

As noted above, ZP-IoT devices may be capable of harvesting energy from one or more wireless energy sources, such as RF signals, thermal energy, solar energy, etc. In some cases, when RF signals are used to harvest energy, a first device (e.g., BS 102, a disaggregated BS as described with respect to FIG. 2, UE 104, or any other device described herein capable of transmitting wireless signals) may transmit an energy signal to a second device, such as a ZP-IoT device (e.g., UE 104, RFID tag 750, etc.). The second device may then harvest energy from the energy signal (e.g., using energy harvesting circuitry, such as energy harvesting circuitry 755 illustrated in FIG. 7) and use this harvested energy to power one or more other components of the second device. In some cases, a portion of the harvested energy may be used to charge a local energy storage device of the second device for later use (i.e., the harvested energy may be stored in the local power storage component). After a sufficient amount of energy is accumulated, the second device may begin to reflect the energy signal radiated onto the second device, known as a backscatter signal or backscatter communication. When reflecting the energy signal, the second device may modulate a particular on-off pattern, corresponding to a set of transmission bits, onto the energy signal. The first device or a third device (e.g., a reader device) may detect and demodulates the reflected pattern, thereby obtaining the set of transmission bits.

In some cases, the RF signals used for energy harvesting for ZP-IoT communication may be encoded using an encoding scheme. In some cases, the encoding scheme may include a manchester encoding scheme, a pulse interval encoding (PIE) scheme, or another encoding scheme used for RFID-based communication.

In some cases, the backscatter communication may refer to a mechanism that allows wireless devices, often referred to as RFID tags, to communicate without active RF components. In a typical scenario, an RFID tag obtains (harvests) energy from an RF transmission from a reader and is also able to modulate and reflect the signals back to the reader (hence, the term backscatter). The signal reflection results from designed mismatch between an antenna and a load impedance at the RFID tag. In some cases, the load impedance can be varied to modulate the reflected signal with information bits the reader can recover by demodulating the reflected signals.

### Example RFID-based Wireless Communications Systems

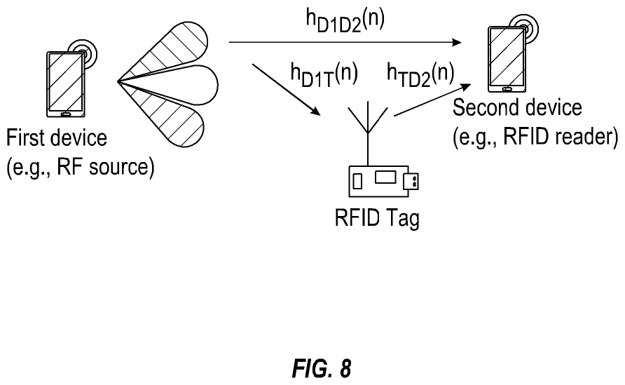

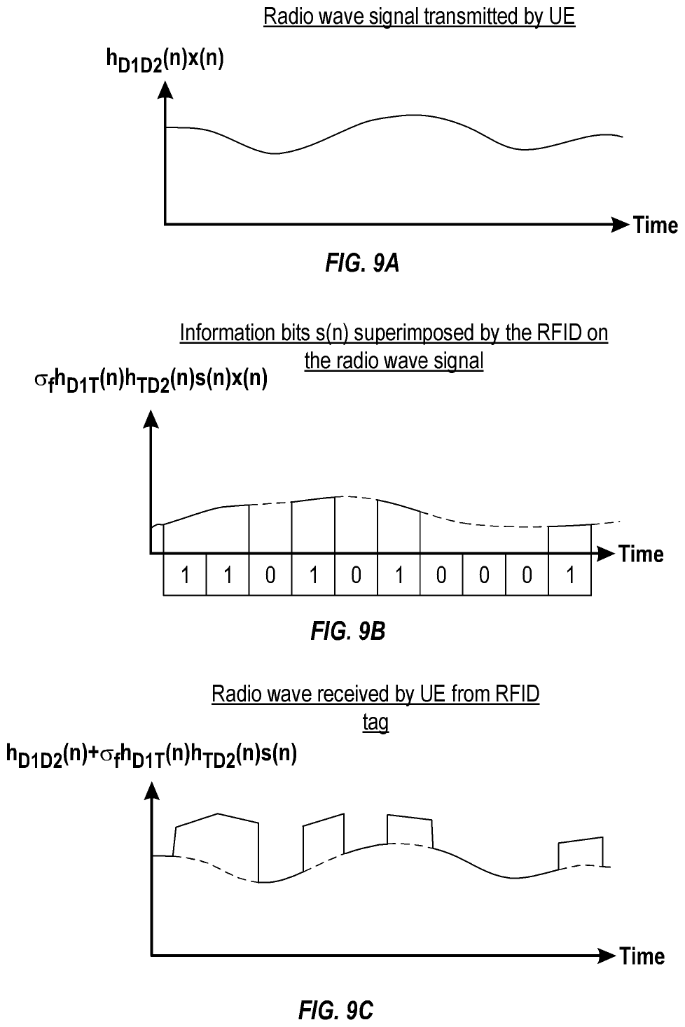

In an radio frequency identification (RFID) based wireless communications system of FIG. 8, a first device (e.g., user equipment (UE) 1, which may be an RF source device) sends a transmission (e.g., unmodulated signal h_{D1D2}(n)×(n) illustrated in FIG. 9A) to a second device (e.g., UE 2, which maybe an RFID reader device).

Referring back to FIG. 8, the first device may send a signal (e.g., a direct link signal) to an RFID tag, which reflects the signal back to the second device. The RFID tag may implement an information modulation method (e.g., an amplitude shift keying (ASK) process) on receiving the signal. That is, the RFID tag may switch ON a reflection process when transmitting information bit is ‘1’ and switch OFF the reflection process when transmitting information bit is ‘0’. For example, as illustrated in FIG. 9B, information bits of the RFID tag may be s(n)∈{0,1}. The received signal at the second device from the RFID tag may be y(n)=(h_{D1D2}(n)+σ_{f}h_{D1T}(n)h_{TD2}(n)s(n))x(n)+noise. When s(n)=0, the reflection process is switched OFF at the RFID tag and the second device may receive the direct link signal (i.e., y(n)=h_{D1D2}(n)x(n)+noise) from the RFID tag. When s(n)=1, the reflection process is switched ON at the RFID tag and the second device may receive the superposition of both the direct link signal and an RFID tag link signal (i.e., y(n)=(h_{D1D2}(n)+σ_{f}h_{D1T}(n)h_{TD2}(n)s(n))x(n)+noise where σ_{f} denotes the reflection coefficient, as illustrated in FIG. 9C) from the RFID tag. In some cases, to receive the transmitted information bit by the RFID tag, the second device may first decode a radio wave signal x(n) based on known h_{D1D2}(n) by treating the RFID tag link signal as interference. The second device may then detect the existence of σ_{f}h_{D1T}(n)h_{TD2}(n)s(n)x(n) by subtracting h_{D1D2}(n)x(n) from y(n).

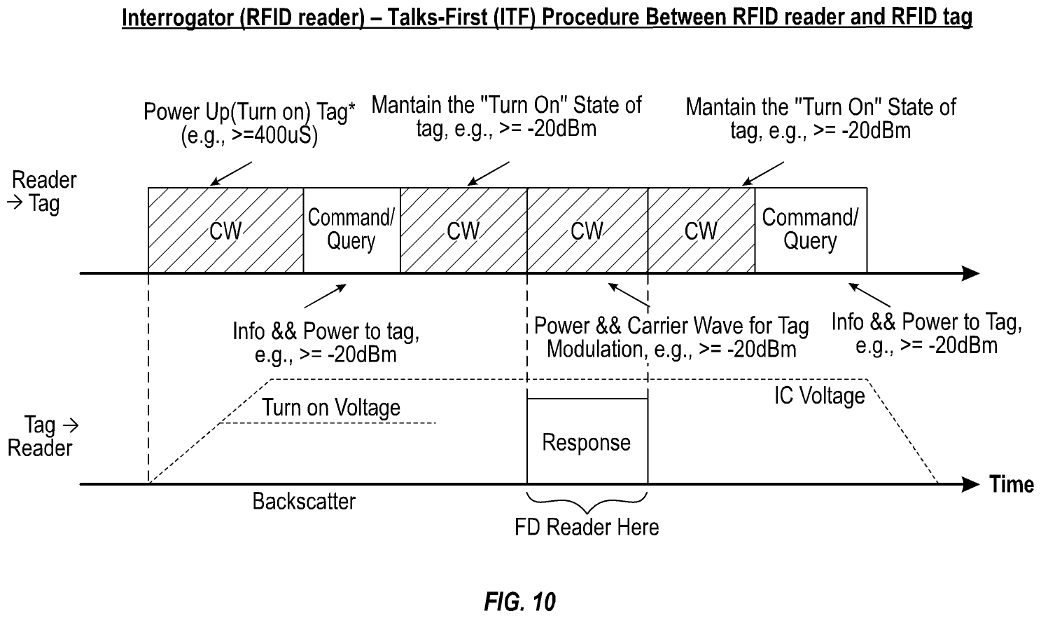

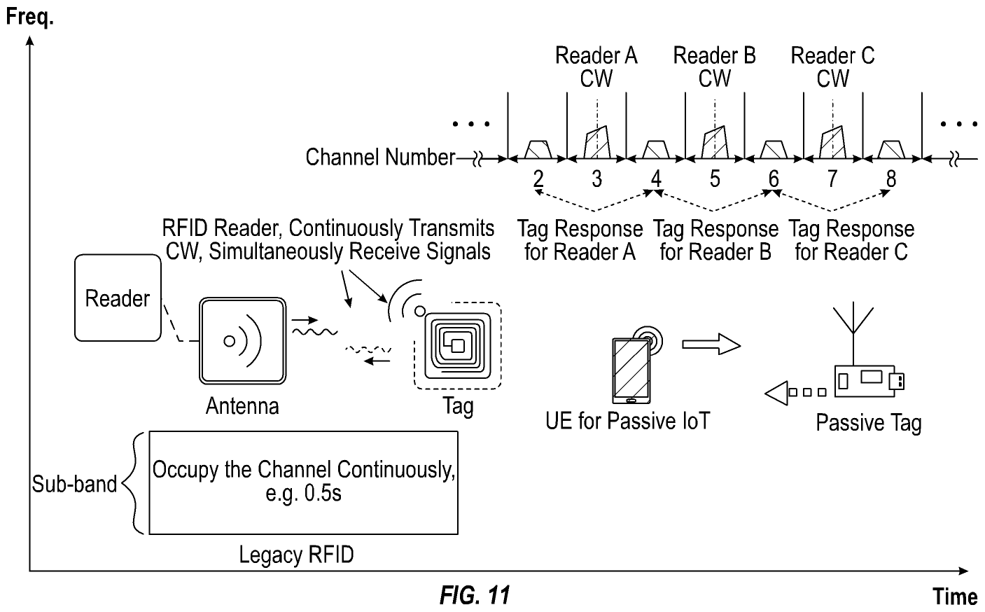

As illustrated in FIG. 10, at a beginning of a communication session in the RFID-based wireless communications system, an RFID source device (e.g., UE in sidelink operations or network entity in Uu link operations) may turn ON an RFID tag by sending a signal (e.g., a continuous wave (CW) signal) to the RFID tag. Once the RFID tag is turned ON (i.e., a predetermined voltage level is achieved), the RFID source device may send at least one command (e.g., backscatter data after a certain time) or query to the RFID tag. In some cases, since the RFID source device may want the RFID tag to remain turned ON, the RFID source device may continue to send the CW signals to the RFID tag. In response to the received command, the RFID tag may send a response (i.e., backscatter the data after the certain time). An RFID reader device (e.g., UE) may read the backscattered data and/or collect the signals from the RFID tag. When the RFID source device may stop sending the CW signals to the RFID device, the RFID device may turn OFF. In some cases, as illustrated in FIG. 11, a same device (e.g., UE) may operate both as the RFID source device and the RFID reader device. That is, the UE that may send signals to the RFID tag, and simultaneously receive the signals from the RFID tag.

The communications of the RFID-based wireless communications system may include feedback signaling. One form of feedback is a hybrid automatic repeat request (HARQ) feedback. Example HARQ feedback reporting signals may include acknowledgement (ACK) signals representing an ACK state, and negative acknowledgement (NACK) signals representing a NACK state. In the RFID-based wireless communications system, there may be a need for multiple different HARQ feedbacks, which may have to be reported by the RFID reader device to the RFID source device, so that the RFID source device does not repeat sending the commands/queries (e.g., when the commands/queries have been correctly received and/or decoded at the RFID tag) and/or the CW signals (e.g., when the CW signals have been correctly received and/or read by the RFID reader device) to the RFID tag.

One such HARQ feedback may be sent in response to the commands/queries sent by the RFID source device to the RFID tag. For example, the RFID reader device may have to send a HARQ feedback to the RFID source device, when the RFID reader device receives information (e.g., related to the command/queries) from the RFID tag. Another HARQ feedback may be related to an entire reading process (e.g., reading of data and CW signals from the RFID tag). For example, the RFID reader device may have to send a HARQ feedback to the RF source device upon reading of the CW signals from the RFID tag, so that the RF source device does not resend the CW signals to the RFID tag (e.g., for the RFID reader device to reread these signals). Accordingly, there is a need to configure multiple HARQ feedback resources for the above-noted HARQ feedbacks.

### Aspects Related to HARQ Feedback Design for UE Helping PIoT Devices in Uu or Sidelink Mode

Aspects of the present disclosure provide apparatuses, methods, processing systems, and computer-readable mediums for managing hybrid automatic repeat request (HARQ) feedback resources.

For example, techniques proposed herein may assign multiple HARQ feedback resources to a radio frequency identification (RFID) reader device operating in an RFID-based wireless communications system. For instance, a network entity may assign dedicated HARQ feedback resources to the RFID reader device for at least a first HARQ feedback (e.g., corresponding to reception/decoding of commands sent by an RFID source device to an RFID tag) and a second HARQ feedback (e.g., corresponding to reading of signals by the RFID reader device from the RFID tag).

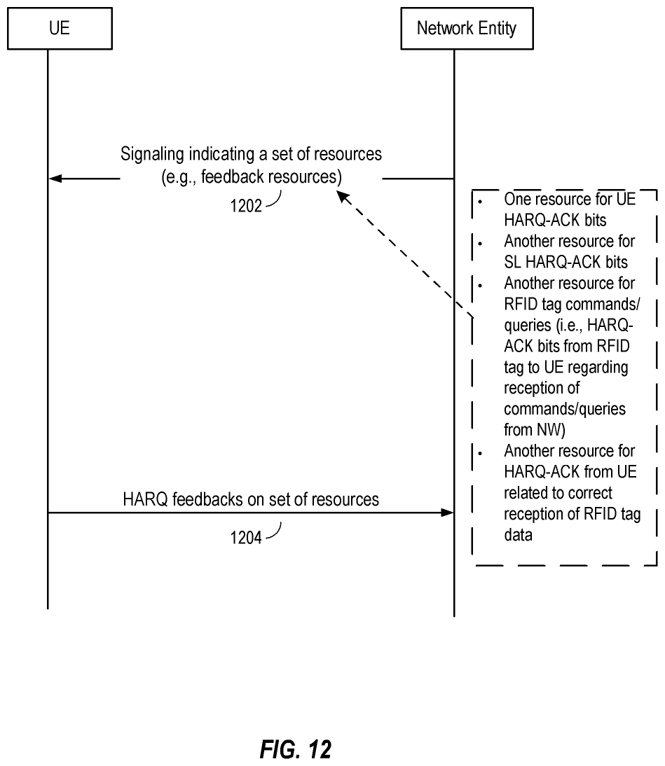

The techniques proposed herein may reduce over-the-air latency by promptly providing the HARQ feedbacks to the RFID source device, so that the RFID source device is able to quickly resend the commands and/or the signals if needed. The techniques proposed herein may work whether or not an actual RFID system is using a sidelink, Uu link or other link. The techniques proposed herein may be understood with reference to FIGS. 12-19.

As illustrated in FIG. 12, at 1202, a network entity (e.g., such as the BS 102 depicted and described with respect to FIGS. 1 and 3 or a disaggregated BS depicted and described with respect to FIG. 2) sends signaling indicating a set of resources to a user equipment (UE) (e.g., such as UE 104 in wireless communication network 100 of FIG. 1) for transmitting a set of transmissions. The signaling maybe layer 1, layer 2, or layer 3 signaling. For example, the network entity may assign dedicated HARQ acknowledgement (ACK) resources (e.g., at least four resources) to the UE and each resource may include bits of a certain type for different transmissions.

At 1204, the UE sends one or more of the set of transmissions (e.g., HARQ feedbacks) on one or more of the set of resources (e.g., HARQ feedback resources).

In certain aspects, each resource of the set of resources may be used to transmit at least one transmission of the set of transmissions. In certain aspects, each resource of the set of resources may be used to transmit at least two transmissions of the set of transmissions. For example, the network entity may assign a single resource to be used to multiplex multiple HARQ-ACK feedbacks (e.g., three HARQ-ACK feedback signals).

In certain aspects, the set of resources may correspond a set of physical uplink control channel (PUCCH) resources. In certain aspects, the set of resources may correspond a set of physical uplink shared channel (PUSCH) resources. In certain aspects, the set of resources may include the PUCCH resources and the PUSCH resources.

In certain aspects, the set of transmissions may correspond to a set of sidelink transmissions. In certain aspects, the set of transmissions may correspond to a set of uplink transmissions. In certain aspects, the set of transmissions may include the uplink transmissions and the sidelink transmissions.

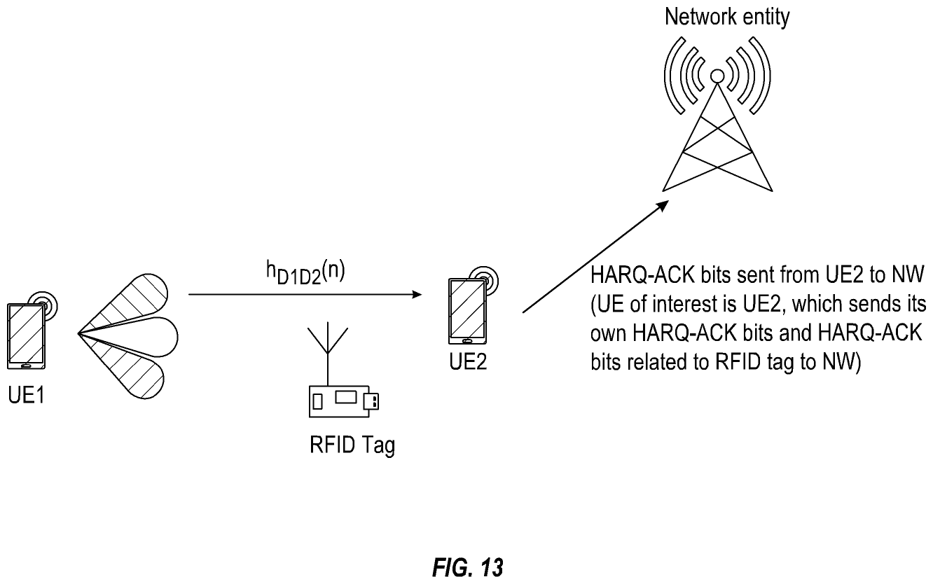

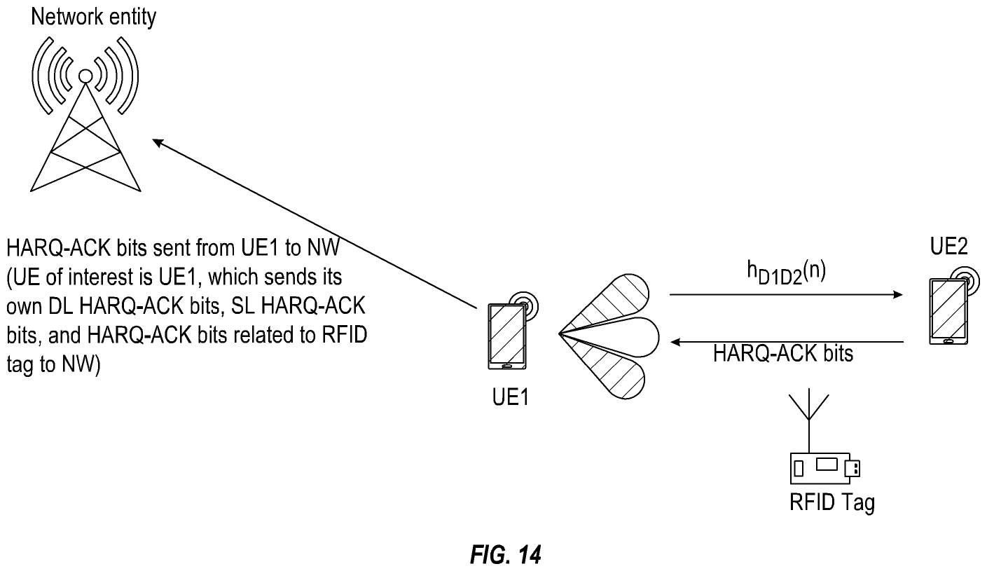

In certain aspects, the set of transmissions may include a first transmission corresponding to a successful or unsuccessful reception of data from at least one harvesting energy device (e.g., RFID tag) at the UE. For example, the network entity may assign a resource to the UE, which may include bits for HARQ-ACK feedback from the UE (which maybe an RFID reader device) related to correct reception of data from the RFID tag. In one example, as illustrated in FIG. 13, one UE (e.g., UE2, which maybe the RFID reader device) may send at least the HARQ-ACK feedback related to correct reception and/or reading of data/signals from the RFID tag to a network entity. In another example, as illustrated in FIG. 14, one UE (e.g., UE1, which maybe the RFID reader device) may send at least the HARQ-ACK feedback related to correct reception and/or reading of data/signals from the RFID tag to a network entity.

In certain aspects, the set of transmissions may include a second transmission corresponding to a successful or unsuccessful reception of a command or a query from a wireless communications device (e.g., network entity or another UE) at the at least one harvesting energy device. In some cases, the UE may first receive one or more HARQ feedback bits from the at least one harvesting energy device, and the second transmission may include information associated with the one or more received HARQ feedback bits from the at least one harvesting energy device. For example, the network entity may assign a resource to the UE, which may include bits for commands and/or queries of the RFID tag (e.g., one bit for each command or query). That is, HARQ-ACK bits may be sent from the RFID tag to the UE (which maybe a reader device) indicating correct reception of modulated codewords (i.e., commands/queries) from the network entity (e.g., RF source). In some cases, the RFID tag may not send any HARQ-ACK bits to the UE. In such cases, the UE may determine that the RFID tag has received/decoded the commands/queries when the RFID tag executes the commands/queries.

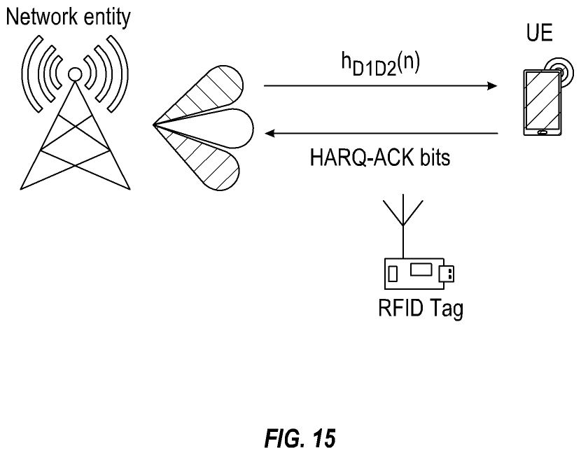

In certain aspects, the set of transmissions may include a third transmission corresponding to a successful or unsuccessful reception of data from the network entity at the UE. For example, the network entity may assign a resource to the UE, which may include bits for a feedback by the UE to the network entity (i.e., HARQ-ACK bits). In one example, as illustrated in FIG. 15, a UE may send at least a HARQ-ACK feedback (e.g., in response to receiving/decoding a signal from a network entity) to the network entity.

In certain aspects, the set of transmissions may include a fourth transmission corresponding to a successful or unsuccessful reception of data from another UE at the UE. For example, the network entity may assign a resource to the UE, which may include bits for a feedback by the UE to the another UE (i.e., sidelink HARQ-ACK bits).

In certain aspects, the UE may receive a first configuration from the network entity configuring the UE to jointly encode a set of information bits corresponding to the set of transmissions (e.g., joint encoding of the different information bit sets when a single resource has to be used to multiplex different HARQ-ACK feedbacks).

In certain aspects, the UE may receive a second configuration from the network entity configuring the UE to use different cyclic shifts for different transmissions of the set of transmissions. For example, when PUCCH 0 is used, the UE may apply different cyclic shifts.

In certain aspects, the UE may receive a third configuration from the network entity configuring the UE to use different power transmission levels for the different transmissions of the set of transmissions. For example, the UE may use different power levels when a single resource has to be used to multiplex different HARQ-ACK feedbacks.

In certain aspects, the UE may receive another configuration from the network entity indicating orthogonal cover codes (OCCs) that may be used for the set of transmissions. For example, the network entity may configure the UE to use the different OCCs for the different transmissions of the set of transmissions. The UE may use the different OCCs when a single resource has to be used to multiplex different HARQ-ACK feedbacks. The OCCs may be applied in a time domain or a frequency domain.

In certain aspects, the UE may receive a fourth configuration from the network entity configuring the UE to multiplex multiple different transmissions of the set of transmissions on different resource elements (REs) or resource blocks (RBs) of the set of resources. For example, when different transmissions have to be multiplexed on different REs/RBs (i.e., separate encoding and rate match has to be performed), a mapping between the different transmissions and the different REs/RBs may be received via the fourth configuration. The mapping maybe based on a procedure to be used. The procedure maybe based on a PUCCH format (0, 1, 2, 3, 4), a number of allocated REs/RBs, and/or a time domain allocation of the PUCCH.

In certain aspects, the signaling may indicate a first sub-codebook of a codebook for the first transmission, a second sub-codebook of the codebook for the second transmission, a third sub-codebook of the codebook for the third transmission, and/or a fourth sub-codebook of the codebook for the fourth transmission. For example, multiple sub-codebooks and/or codebooks maybe provided where the first sub-codebook/codebook is for HARQ-ACK bits related to correct reception/reading of RFID tag data (i.e., response feedback), the second sub-codebook/codebook is for the RFID tag command/query HARQ-ACK bits (i.e., command feedback), the third sub-codebook/codebook is for UE's own HARQ-ACK bits (i.e., Uu feedback), and the fourth sub-codebook/codebook for sidelink HARQ-ACK bits (i.e., sidelink feedback).

In certain aspects, the signaling may indicate a maximum size of the first sub-codebook, the second sub-codebook, the third sub-codebook, and/or the fourth sub-codebook. For example, a maximum size for each sub-codebook (e.g., a maximum number of HARQ-ACK bits) may be provided. In some cases, when a number of bits for each sub-codebook is not achieving a predefined bit limit, some padding may be done (e.g., to avoid codebook mismatch between the network entity and the UE). In some cases, the UE may have a maximum number of HARQ-ACK bits for each type of transmission. In such cases, to avoid missing bits when sending the transmission, the UE may pad each sub-codebook bits with zero bits such that the size of sub-codebook bits is the maximum number of HARQ-ACK bits.

In certain aspects, the signaling may indicate a maximum number of information bits for the first transmission, the second transmission, the third transmission, and/or the fourth transmission. For example, the network entity may define a maximum number of HARQ-ACK bits for each type of transmission (e.g., the command feedback, the response feedback, the Uu feedback, and the sidelink feedback) when there are multiple codebooks or sub-codebooks.

In certain aspects, the signaling may indicate at least one counter for the first sub-codebook, the second sub-codebook, the third sub-codebook, or the fourth sub-codebook. The at least one counter may correspond to a counter downlink assignment (cDAI) indicating a number of transport blocks (TBs) or a total downlink assignment (tDAI) indicating a total number of scheduled carriers. For example, the network entity may define counters (e.g., cDAI/tDAI) for each sub-codebook or across codebooks that are multiplexed, and the counters may be added to each signal (i.e., command, response, downlink control information (DCI)).

In certain aspects, there may be two harvesting energy devices such as a first harvesting energy device and a second harvesting energy device. In this case, the first transmission may correspond to the successful or unsuccessful reception of the data from the first harvesting energy device and the second harvesting energy device at the UE. The first transmission indicates an identification (ID) of the first harvesting energy device and/or the second harvesting energy device. For example, when the UE has to send the HARQ-ACK bits for multiple RFID tags in a same PUCCH resource, IDs of the RFID tags may be included in the HARQ-ACK bits.

In certain aspects, the UE may transmit each transmission corresponding to the successful or unsuccessful reception of the data from each harvesting energy device at the UE on a different resource of the set of resources. In certain aspects, the signaling indicates a resource of the set of resources for transmitting each transmission corresponding to the successful or unsuccessful reception of the data from each harvesting energy device at the UE. For example, the UE may send each RFID tag related HARQ feedback bits on a different uplink resource (and in such cases it may not be important to add RFID tag ID in the HARQ feedback bits). Furthermore, the network entity may indicate to the UE (e.g., via a scheduling or non-scheduling DCI, a radio resource control (RRC) message, or a medium access control (MAC) control element (CE)) which uplink resource ID or resource to use for each RFID tag ID or for every source device ID, destination device ID, RFID tag ID, or every RFID read process ID (i.e., an ID given to the entire RFID tag process).

In certain aspects, the set of resources may correspond to a set of physical uplink feedback channel (PSFCH) resources. In certain aspects, the network entity may allocate physical resource blocks (PRBs) for each PSFCH resource within a resource pool including the set of PSFCH resources (e.g., each PSFCH may have a periodicity as well).

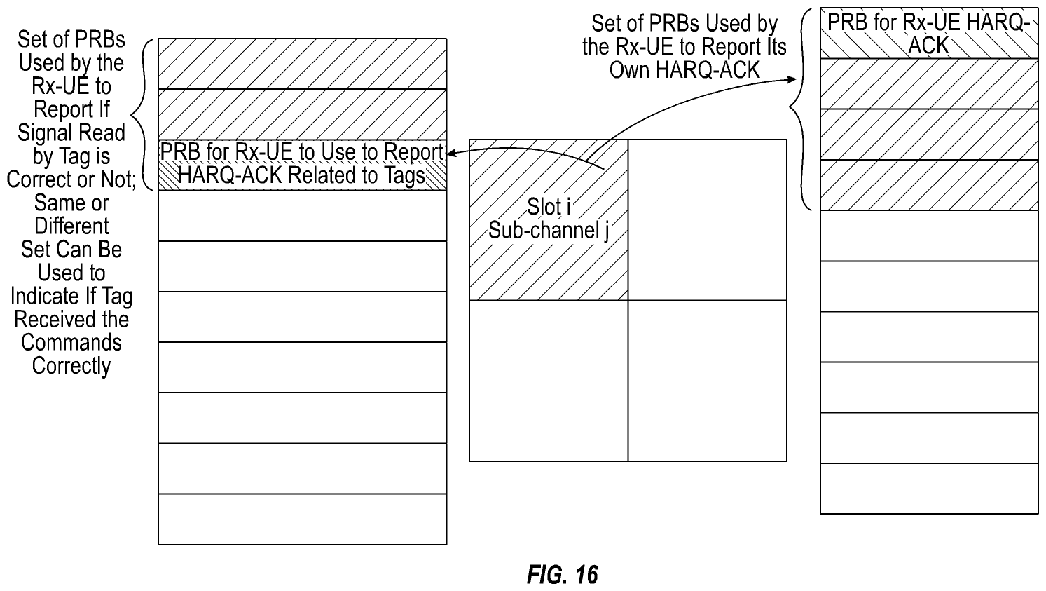

In certain aspects, the signaling may indicate a first set of PRBs of the set of resources to use for transmitting a feedback (e.g., response feedback bits) corresponding to the successful or unsuccessful reception of the data from the at least one harvesting energy device at the UE. Each PRB of the first set of PRBs may be associated with a source device ID, a destination device ID, an ID of the at least one harvesting energy device and/or an ID corresponding to a type of the feedback for the at least one harvesting energy device. The UE may transmit the response feedback bits corresponding to the successful or unsuccessful reception of the data on the first set of PRBs to the another UE. As illustrated in FIG. 16, a receiver UE (which may be an RFID reader device) may determine the first set of PRBs to use for transmitting the response feedback bits, based on the source device ID (e.g., transmitter UE ID), the destination device ID (e.g., receiver UE ID), the ID of the at least one harvesting energy device and/or the ID corresponding to a type of the feedback for the at least one harvesting energy device.

In certain aspects, the UE may determine the first set of PRBs of the set of resources to use for transmitting the response feedback bits corresponding to the successful or unsuccessful reception of the data from the at least one harvesting energy device at the UE, based on a receive time of the data from the at least one harvesting energy device.

In certain aspects, the signaling may indicate a second set of PRBs of the set of resources to use for transmitting a feedback (e.g., command feedback bits) corresponding to the successful or unsuccessful reception of the command or the query from the another UE at the at least one harvesting energy device. Each PRB of the second set of PRBs may be associated with a source device ID, a destination device ID, an ID of the at least one harvesting energy device and/or an ID corresponding to a type of the feedback for the at least one harvesting energy device. The UE may transmit the command bits corresponding to the successful or unsuccessful reception of the command or the query on the second set of PRBs to the another UE.

In certain aspects, the UE may determine the second set of PRBs of the set of resources to use for transmitting the command feedback bits corresponding to the successful or unsuccessful reception of the command or the query from the another UE at the at least one harvesting energy device, based on a receive time of the command or the query from the another UE. The UE transmits the command feedback bits corresponding to the successful or unsuccessful reception of the command or the query on the second set of PRBs to the another UE.

In some cases, the network entity may allocate new PRBs to the UE for feeding back HARQ-ACK bits related to the RFID tag. Each set of bits may have its own PRB sets. For example, the command feedback bits may be a different set of PRBs than the response feedback bits. In some cases, the RFID tag bits may be on a same PRB set (i.e., different from the UE's own HARQ-ACK bits). In a sidelink system, one UE (e.g., a receiver UE) may report to another UE (e.g., transmitter UE, which maybe an RF source device) using a corresponding set of PRB bits. During the resource assignment (i.e., to determine the PRB set to use), the receiver UE may use a source device ID (e.g., the transmitter UE ID), a destination device ID (e.g., the receiver UE ID), the RFID tag ID, and/or ID related to the type of HARQ-ACK for the RFID tag. In some cases, time to receive the command/query by the RFID tag or the response from the RFID tag may be used to determine the PRB among the command or the response. In other cases, all commands/responses within a certain time interval may use same PRBs using a different cyclic shift.

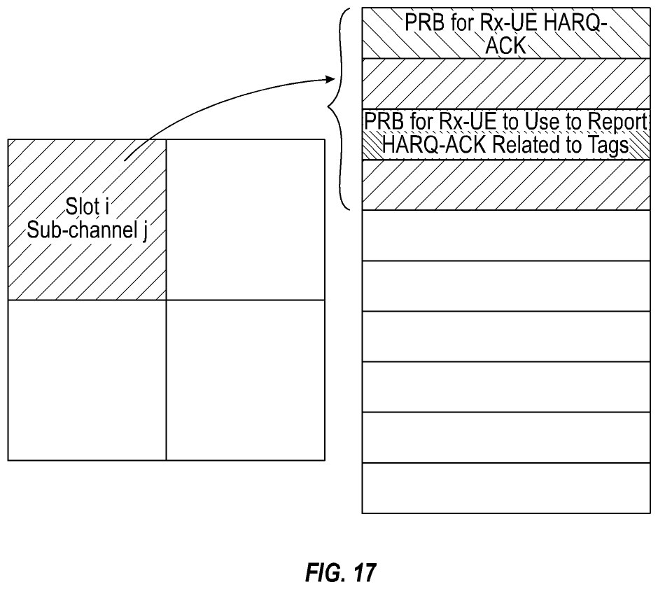

In certain aspects, the UE transmits each transmission corresponding to the successful or unsuccessful reception of the data from each harvesting energy device at the UE on a same set of PRBs of the set of resources that are used for sidelink data transmissions. In one aspect, the UE may select one or more PRBs from the set of PRBs, for transmitting each transmission corresponding to the successful or unsuccessful reception of the data from each harvesting energy device at the UE, based on an ID of the at least one harvesting energy device. In another aspect, the UE may select one or more PRBs from the set of PRBs, for transmitting each transmission corresponding to the successful or unsuccessful reception of the data from each harvesting energy device at the UE, based on one or more cyclic shifts associated with an ID of the at least one harvesting energy device. For example, the receiver UE may transmit a feedback (e.g., RFID tag related HARQ-ACK bits) in the same set of PRBs that may be used for data transmission (e.g., legacy PRBs) using different cyclic shifts (e.g., each RFID tag ID may be associated with a different cyclic shift or a set of cyclic shifts) and/or a different PRB based on the RFID tag ID (as illustrated in FIG. 17).

In certain aspects, the signaling may indicate a set of PRBs of the set of resources to use for transmitting the set of transmissions. The set of PRBs may include a first subset of PRBs for the first transmission of the set of transmissions and a second subset of PRBs for the second transmission of the set of transmissions. The first subset of PRBs may be associated with an ID of a first harvesting energy device. The second subset of PRBs may be associated with an ID of a second harvesting energy device. For example, the PRBs used for the HARQ-ACK bits corresponding to the command feedback and the HARQ-ACK bits corresponding to the response feedback may have different configured IDs to separate them per RFID tag.

FIG. 18 shows an example of a method 1800 for wireless communications by a UE, such as UE 104 of FIGS. 1 and 3.

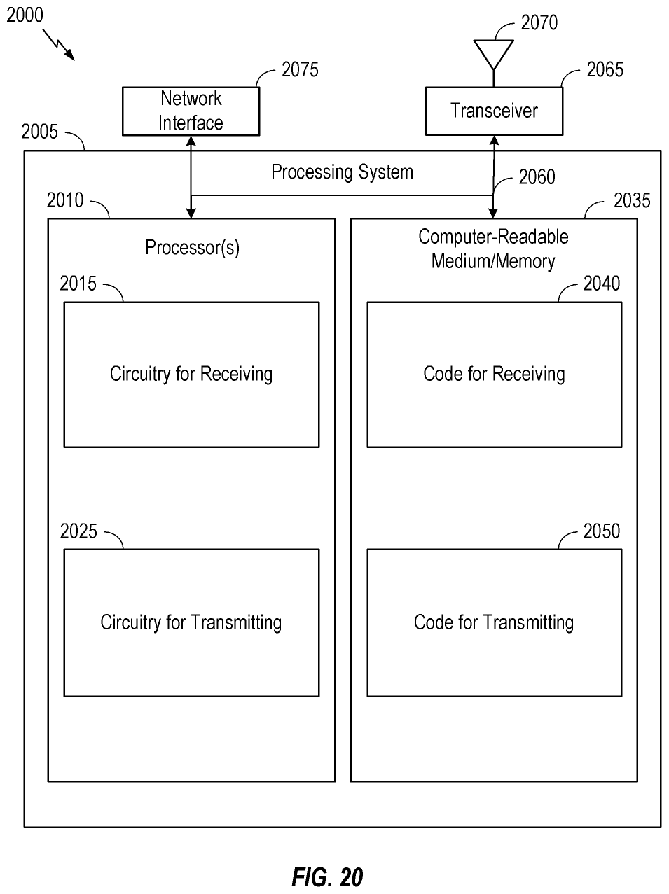

Method 1800 begins at step 1805 with receiving signaling indicating a set of resources from a network entity for transmitting a set of transmissions comprising at least one of: a first transmission corresponding to a successful or unsuccessful reception of data from at least one harvesting energy device at the UE, or a second transmission corresponding to a successful or unsuccessful reception of a command or a query from a wireless communications device at the at least one harvesting energy device. In some cases, the operations of this step refer to, or may be performed by, circuitry for receiving and/or code for receiving as described with reference to FIG. 20.

Method 1800 then proceeds to step 1810 with transmitting the set of transmissions on the set of resources. In some cases, the operations of this step refer to, or may be performed by, circuitry for transmitting and/or code for transmitting as described with reference to FIG. 20.

In one aspect, method 1800, or any aspect related to it, may be performed by an apparatus, such as communications device 2000 of FIG. 20, which includes various components operable, configured, or adapted to perform the method 1800. Communications device 2000 is described below in further detail.

Note that FIG. 18 is just one example of a method, and other methods including fewer, additional, or alternative steps are possible consistent with this disclosure.

FIG. 19 shows an example of a method 1900 for wireless communications by a network entity, such as BS 102 of FIGS. 1 and 3, or a disaggregated BS as discussed with respect to FIG. 2.

Method 1900 begins at step 1905 with transmitting signaling indicating a set of resources to a UE for a set of transmissions comprising at least one of: a first transmission corresponding to a successful or unsuccessful reception of data from at least one harvesting energy device at the UE, or a second transmission corresponding to a successful or unsuccessful reception of a command or a query from a wireless communications device at the at least one harvesting energy device. In some cases, the operations of this step refer to, or may be performed by, circuitry for transmitting and/or code for transmitting as described with reference to FIG. 20.

Method 1900 then proceeds to step 1910 with receiving the set of transmissions on the set of resources. In some cases, the operations of this step refer to, or may be performed by, circuitry for receiving and/or code for receiving as described with reference to FIG. 20.

In one aspect, method 1900, or any aspect related to it, may be performed by an apparatus, such as communications device 2000 of FIG. 20, which includes various components operable, configured, or adapted to perform the method 1900. Communications device 2000 is described below in further detail.

Note that FIG. 19 is just one example of a method, and other methods including fewer, additional, or alternative steps are possible consistent with this disclosure.

### Example Communications Device

FIG. 20 depicts aspects of an example communications device 2000. In some aspects, communications device 2000 is a user equipment, such as UE 104 described above with respect to FIGS. 1 and 3. In some aspects, communications device 2000 is a network entity, such as BS 102 of FIGS. 1 and 3, or a disaggregated BS as discussed with respect to FIG. 2.

The communications device 2000 includes a processing system 2005 coupled to the transceiver 2065 (e.g., a transmitter and/or a receiver). In some aspects (e.g., when communications device 2000 is a network entity), processing system 2005 may be coupled to a network interface 2075 that is configured to obtain and send signals for the communications device 2000 via communication link(s), such as a backhaul link, midhaul link, and/or fronthaul link as described herein, such as with respect to FIG. 2. The transceiver 2065 is configured to transmit and receive signals for the communications device 2000 via the antenna 2070, such as the various signals as described herein. The processing system 2005 may be configured to perform processing functions for the communications device 2000, including processing signals received and/or to be transmitted by the communications device 2000.

The processing system 2005 includes one or more processors 2010. In various aspects, the one or more processors 2010 may be representative of one or more of receive processor 358, transmit processor 364, TX MIMO processor 366, and/or controller/processor 380, as described with respect to FIG. 3. In various aspects, one or more processors 2010 may be representative of one or more of receive processor 338, transmit processor 320, TX MIMO processor 330, and/or controller/processor 340, as described with respect to FIG. 3. The one or more processors 2010 are coupled to a computer-readable medium/memory 2035 via a bus 2060. In certain aspects, the computer-readable medium/memory 2035 is configured to store instructions (e.g., computer-executable code) that when executed by the one or more processors 2010, cause the one or more processors 2010 to perform: the method 1800 described with respect to FIG. 18, or any aspect related to it and/or the method 1900 described with respect to FIG. 19, or any aspect related to it. Note that reference to a processor performing a function of communications device 2000 may include one or more processors 2010 performing that function of communications device 2000.

In the depicted example, computer-readable medium/memory 2035 stores code (e.g., executable instructions), such as code for receiving 2040 and code for transmitting 2050. Processing of the code for receiving 2040 and code for transmitting 2050 may cause the communications device 2000 to perform: the method 1800 described with respect to FIG. 18, or any aspect related to it and/or the method 1900 described with respect to FIG. 19.

The one or more processors 2010 include circuitry configured to implement (e.g., execute) the code stored in the computer-readable medium/memory 2035, including circuitry such as circuitry for receiving 2015 and circuitry for transmitting 2025. Processing with circuitry for receiving 2015 and circuitry for transmitting 2025 may cause the communications device 2000 to perform: the method 1800 described with respect to FIG. 18, or any aspect related to it and/or the method 1900 described with respect to FIG. 19.

Various components of the communications device 2000 may provide means for performing: the method 1800 described with respect to FIG. 18, or any aspect related to it and/or the method 1900 described with respect to FIG. 19. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1265 and the antenna 1270 of the communications device 2000 in FIG. 20. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1365 and the antenna 1370 of the communications device 2000 in FIG. 20.

### EXAMPLE CLAUSES

Implementation examples are described in the following numbered clauses:

Clause 1: A method for wireless communication by a user equipment (UE), comprising: receiving signaling indicating a set of resources from a network entity for transmitting a set of transmissions comprising at least one of: a first transmission corresponding to a successful or unsuccessful reception of data from at least one harvesting energy device at the UE, or a second transmission corresponding to a successful or unsuccessful reception of a command or a query from a wireless communications device at the at least one harvesting energy device; and transmitting the set of transmissions on the set of resources.

Clause 2: The method alone or in combination with the first clause, wherein: the set of transmissions corresponds to a set of uplink transmissions; the set of resources corresponds to at least of: a set of physical uplink control channel (PUCCH) resources or a set of physical uplink shared channel (PUSCH) resources; the wireless communications device corresponds to the network entity; and the at least one harvesting energy device corresponds to at least one radio frequency identification (RFID) tag.

Clause 3: The method alone or in combination with the second clause, further comprising receiving one or more hybrid automatic repeat request (HARQ) feedback bits from the at least one harvesting energy device, wherein the one or more HARQ feedback bits indicate information carried by the second transmission.

Clause 4: The method alone or in combination with the second clause, wherein the set of transmissions further comprises at least one of: a third transmission corresponding to a successful or unsuccessful reception of data from the network entity at the UE, or a fourth transmission corresponding to a successful or unsuccessful reception of data from another UE at the UE.

Clause 5: The method alone or in combination with the first clause, wherein each resource of the set of resources is for transmitting at least one transmission of the set of transmissions.

Clause 6: The method alone or in combination with the first clause, wherein each resource of the set of resources is for transmitting at least two transmissions of the set of transmissions.

Clause 7: The method alone or in combination with the first clause, further comprising receiving a configuration configuring the UE for at least one of: joint encoding of a set of information bits corresponding to the set of transmissions; using different cyclic shifts for different transmissions of the set of transmissions; using different power transmission levels for the different transmissions of the set of transmissions; or multiplexing the different transmissions of the set of transmissions on different resource elements (REs) or resource blocks (RBs) of the set of resources.

Clause 8: The method alone or in combination with the fourth clause, wherein the signaling indicates at least one of: a first sub-codebook of a codebook for the first transmission; a second sub-codebook of the codebook for the second transmission; a third sub-codebook of the codebook for the third transmission; and a fourth sub-codebook of the codebook for the fourth transmission.

Clause 9: The method alone or in combination with the eighth clause, wherein the signaling indicates a maximum size of at least one of: the first sub-codebook; the second sub-codebook; the third sub-codebook; or the fourth sub-codebook.

Clause 10: The method alone or in combination with the eighth clause, wherein the signaling indicates a maximum number of information bits for at least one of: the first transmission; the second transmission; the third transmission; or the fourth transmission.

Clause 11: The method alone or in combination with the eighth clause, wherein: the signaling indicates at least one counter for at least one of: the first sub-codebook; the second sub-codebook; the third sub-codebook; or the fourth sub-codebook, and the at least one counter corresponds to a counter downlink assignment (cDAI) indicating a number of transport blocks (TBs) or a total downlink assignment (tDAI) indicating a total number of scheduled carriers.

Clause 12: The method alone or in combination with the first clause, wherein: the at least one harvesting energy device corresponds to a first harvesting energy device and a second harvesting energy device; the first transmission corresponds to the successful or unsuccessful reception of the data from the first harvesting energy device and the second harvesting energy device at the UE; the transmitting further comprises transmitting the first transmission on a first resource of the set of resources; and the first transmission indicates an identification (ID) of the first harvesting energy device and the second harvesting energy device.

Clause 13: The method alone or in combination with the first clause, wherein the transmitting comprises transmitting each transmission corresponding to the successful or unsuccessful reception of the data from each harvesting energy device at the UE on a different resource of the set of resources.

Clause 14: The method alone or in combination with the first clause, wherein the signaling indicates a resource of the set of resources for transmitting each transmission corresponding to the successful or unsuccessful reception of the data from each harvesting energy device at the UE.

Clause 15: The method alone or in combination with the first clause, wherein: the set of resources corresponds to a set of physical uplink feedback channel (PSFCH) resources; the set of transmissions corresponds to at least one of: a set of sidelink transmissions or a set of uplink transmissions; the wireless communications device corresponds to another UE; and the at least one harvesting energy device corresponds to at least one radio frequency identification (RFID) tag.

Clause 16: The method alone or in combination with the fifteenth clause, wherein the signaling indicates a first set of physical resource blocks (PRBs) of the set of resources to use for transmitting feedback bits corresponding to the successful or unsuccessful reception of the data from the at least one harvesting energy device at the UE.

Clause 17: The method alone or in combination with the sixteenth clause, wherein each PRB of the first set of PRBs is associated with at least one of: a source device identification (ID); a destination device ID; an ID of the at least one harvesting energy device; or an ID corresponding to a type of a feedback for the at least one harvesting energy device.

Clause 18: The method alone or in combination with the seventeenth clause, wherein the transmitting comprises transmitting the feedback bits corresponding to the successful or unsuccessful reception of the data on the first set of PRBs to the another UE.

Clause 19: The method alone or in combination with the fifteenth clause, wherein the transmitting comprises: determining a first set of physical resource blocks (PRBs) of the set of resources to use for transmitting feedback bits corresponding to the successful or unsuccessful reception of the data from the at least one harvesting energy device at the UE, based on a receive time of the data from the at least one harvesting energy device; and transmitting the feedback bits corresponding to the successful or unsuccessful reception of the data on the first set of PRBs to the another UE.

Clause 20: The method alone or in combination with the fifteenth clause, wherein the signaling indicates a second set of physical resource blocks (PRBs) of the set of resources to use for transmitting feedback bits corresponding to the successful or unsuccessful reception of the command or the query from the another UE at the at least one harvesting energy device.

Clause 21: The method alone or in combination with the twentieth clause, wherein each PRB of the second set of PRBs is associated with at least one of: a source device identification (ID); a destination device ID; an ID of the at least one harvesting energy device; or an ID corresponding to a type of a feedback for the at least one harvesting energy device.

Clause 22: The method alone or in combination with the twenty-first clause, wherein the transmitting comprises transmitting the feedback bits corresponding to the successful or unsuccessful reception of the command or the query on the second set of PRBs to the another UE.

Clause 22: The method alone or in combination with the fifteenth clause, wherein the transmitting comprises: determining a second set of physical resource blocks (PRBs) of the set of resources to use for transmitting feedback bits corresponding to the successful or unsuccessful reception of the command or the query from the another UE at the at least one harvesting energy device, based on a receive time of the command or the query from the another UE; and transmitting the feedback bits corresponding to the successful or unsuccessful reception of the command or the query on the second set of PRBs to the another UE.

Clause 24: The method alone or in combination with the first clause, wherein the transmitting comprises transmitting each transmission corresponding to the successful or unsuccessful reception of the data from each harvesting energy device at the UE on a same set of physical resource blocks (PRBs) of the set of resources that are used for sidelink data transmissions.

Clause 25: The method alone or in combination with the twenty-fourth clause, further comprising selecting one or more PRBs from the set of PRBs, for transmitting each transmission corresponding to the successful or unsuccessful reception of the data from each harvesting energy device at the UE, based on an identification (ID) of the at least one harvesting energy device.

Clause 26: The method alone or in combination with the twenty-fourth clause, further comprising selecting one or more PRBs from the set of PRBs, for transmitting each transmission corresponding to the successful or unsuccessful reception of the data from each harvesting energy device at the UE, based on one or more cyclic shifts associated with an identification (ID) of the at least one harvesting energy device.

Clause 27: The method alone or in combination with the fifteenth clause, wherein: the signaling indicates a set of physical resource blocks (PRBs) of the set of resources to use for transmitting the set of transmissions; and the set of PRBs comprises a first subset of PRBs for the first transmission of the set of transmissions and a second subset of PRBs for the second transmission of the set of transmissions.

Clause 28: The method alone or in combination with the fifteenth clause, wherein: the signaling indicates a set of physical resource blocks (PRBs) of the set of resources to use for transmitting the set of transmissions; the set of PRBs comprises a first subset of PRBs and a second subset of PRBs; the first subset of PRBs are associated with an ID of a first harvesting energy device; and the second subset of PRBs are associated with an ID of a second harvesting energy device.

Clause 30: A method for wireless communication by a network entity, comprising: transmitting signaling indicating a set of resources to a user equipment (UE) for a set of transmissions comprising at least one of: a first transmission corresponding to a successful or unsuccessful reception of data from at least one harvesting energy device at the UE, or a second transmission corresponding to a successful or unsuccessful reception of a command or a query from a wireless communications device at the at least one harvesting energy device; and receiving the set of transmissions on the set of resources.

Clause 31: The method alone or in combination with the thirtieth clause, wherein: the set of transmissions corresponds to a set of uplink transmissions; the set of resources corresponds to at least of: a set of physical uplink control channel (PUCCH) resources or a set of physical uplink shared channel (PUSCH) resources; the wireless communications device corresponds to the network entity; and the at least one harvesting energy device corresponds to at least one radio frequency identification (RFID) tag.

Clause 32: An apparatus, comprising: a memory comprising executable instructions; and a processor configured to execute the executable instructions and cause the apparatus to perform a method in accordance with any one of Clauses 1-31.

Clause 33: An apparatus, comprising means for performing a method in accordance with any one of Clauses 1-31.

Clause 34: A non-transitory computer-readable medium comprising executable instructions that, when executed by a processor of an apparatus, cause the apparatus to perform a method in accordance with any one of Clauses 1-31.

Clause 35: A computer program product embodied on a computer-readable storage medium comprising code for performing a method in accordance with any one of Clauses 1-31.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A user equipment (UE) for wireless communication, comprising:
a memory comprising computer-executable instructions; and
a processor configured to execute the computer-executable instructions and cause the UE to:
receive signaling indicating a set of resources from a network entity for transmitting a set of transmissions comprising at least one of:
a first transmission corresponding to a successful or unsuccessful reception of data from at least one harvesting energy device at the UE, or
a second transmission corresponding to a successful or unsuccessful reception of a command or a query from a wireless communications device at the at least one harvesting energy device; and
transmit the set of transmissions on the set of resources.

2. The UE of claim 1, wherein:
the set of transmissions corresponds to a set of uplink transmissions;
the set of resources corresponds to at least of: a set of physical uplink control channel (PUCCH) resources or a set of physical uplink shared channel (PUSCH) resources;
the wireless communications device corresponds to the network entity; and
the at least one harvesting energy device corresponds to at least one radio frequency identification (RFID) tag.

3. The UE of claim 2, wherein the processor is further configured to execute the computer-executable instructions and cause the UE to: receive one or more hybrid automatic repeat request (HARQ) feedback bits from the at least one harvesting energy device, wherein the one or more HARQ feedback bits indicate information carried by the second transmission.

4. The UE of claim 2, wherein the set of transmissions further comprises at least one of:
a third transmission corresponding to a successful or unsuccessful reception of data from the network entity at the UE, or
a fourth transmission corresponding to a successful or unsuccessful reception of data from another UE at the UE.

5. The UE of claim 1, wherein each resource of the set of resources is for transmitting at least one transmission of the set of transmissions.

6. The UE of claim 1, wherein each resource of the set of resources is for transmitting at least two transmissions of the set of transmissions.

7. The UE of claim 1, wherein the processor is further configured to execute the computer-executable instructions and cause the UE to receive a configuration configuring the UE for at least one of:
jointly encode a set of information bits corresponding to the set of transmissions;
use different cyclic shifts for different transmissions of the set of transmissions;
use different power transmission levels for the different transmissions of the set of transmissions; or
multiplex the different transmissions of the set of transmissions on different resource elements (REs) or resource blocks (RBs) of the set of resources.

8. The UE of claim 4, wherein the signaling indicates at least one of:
a first sub-codebook of a codebook for the first transmission;
a second sub-codebook of the codebook for the second transmission;
a third sub-codebook of the codebook for the third transmission; and
a fourth sub-codebook of the codebook for the fourth transmission.

9. The UE of claim 8, wherein the signaling indicates a maximum size of at least one of the first sub-codebook; the second sub-codebook; the third sub-codebook; or the fourth sub-codebook.

10. The UE of claim 8, wherein the signaling indicates a maximum number of information bits for at least one of: the first transmission; the second transmission; the third transmission; or the fourth transmission.

11. The UE of claim 8, wherein:
the signaling indicates at least one counter for at least one of: the first sub-codebook; the second sub-codebook; the third sub-codebook; or the fourth sub-codebook, and
the at least one counter corresponds to a counter downlink assignment (cDAI) indicating a number of transport blocks (TBs) or a total downlink assignment (tDAI) indicating a total number of scheduled carriers.

12. The UE of claim 1, wherein:
the at least one harvesting energy device corresponds to a first harvesting energy device and a second harvesting energy device;
the first transmission corresponds to the successful or unsuccessful reception of the data from the first harvesting energy device and the second harvesting energy device at the UE;
the transmitting further comprises transmitting the first transmission on a first resource of the set of resources; and
the first transmission indicates an identification (ID) of the first harvesting energy device and the second harvesting energy device.

13. The UE of claim 1, wherein the transmit comprises transmit each transmission corresponding to the successful or unsuccessful reception of the data from each harvesting energy device at the UE on a different resource of the set of resources.

14. The UE of claim 1, wherein the signaling indicates a resource of the set of resources for transmitting each transmission corresponding to the successful or unsuccessful reception of the data from each harvesting energy device at the UE.

15. The UE of claim 1, wherein:
the set of resources corresponds to a set of physical uplink feedback channel (PSFCH) resources;
the set of transmissions corresponds to at least one of: a set of sidelink transmissions or a set of uplink transmissions;
the wireless communications device corresponds to another UE; and
the at least one harvesting energy device corresponds to at least one radio frequency identification (RFID) tag.

16. The UE of claim 15, wherein:
the signaling indicates a first set of physical resource blocks (PRBs) of the set of resources to use for transmitting feedback bits corresponding to the successful or unsuccessful reception of the data from the at least one harvesting energy device at the UE; and
each PRB of the first set of PRBs is associated with at least one of:
a source device identification (ID);
a destination device ID;
an ID of the at least one harvesting energy device; or
an ID corresponding to a type of a feedback for the at least one harvesting energy device.

17. The UE of claim 16, wherein the transmit comprises transmit the feedback bits corresponding to the successful or unsuccessful reception of the data on the first set of PRBs to the another UE.

18-26. (canceled)

27. A network entity for wireless communication, comprising:
a memory comprising computer-executable instructions; and
a processor configured to execute the computer-executable instructions and cause the network entity to:
transmit signaling indicating a set of resources to a user equipment (UE) for a set of transmissions comprising at least one of:
a first transmission corresponding to a successful or unsuccessful reception of data from at least one harvesting energy device at the UE, or
a second transmission corresponding to a successful or unsuccessful reception of a command or a query from a wireless communications device at the at least one harvesting energy device; and
receive the set of transmissions on the set of resources.

28. The network entity of claim 27, wherein:
the set of transmissions corresponds to a set of uplink transmissions;
the set of resources corresponds to at least of: a set of physical uplink control channel (PUCCH) resources or a set of physical uplink shared channel (PUSCH) resources;
the wireless communications device corresponds to the network entity; and
the at least one harvesting energy device corresponds to at least one radio frequency identification (RFID) tag.

29. A method for wireless communication by a user equipment (UE), comprising:
receiving signaling indicating a set of resources from a network entity for transmitting a set of transmissions comprising at least one of:
a first transmission corresponding to a successful or unsuccessful reception of data from at least one harvesting energy device at the UE, or
a second transmission corresponding to a successful or unsuccessful reception of a command or a query from a wireless communications device at the at least one harvesting energy device; and
transmitting the set of transmissions on the set of resources.

30. (canceled)
